(19) United States
(12) Patent Application Publication
(10) Pub. No.: US 2026/0323799 A1
(43) Pub. Date: Oct. 15, 2026

(54) LIGHT-EMITTING ELEMENT DRIVE DEVICE, LIGHT-EMITTING SYSTEM, BACKLIGHT AND DISPLAY DEVICE

(71) Applicant: ROHM CO., LTD., Kyoto (JP)

(72) Inventor: Kenji YAMADA, Kyoto (JP)

(21) Appl. No.: 19/694,198

(22) Filed: Jun. 1, 2026

Related U.S. Application Data
(63) Continuation of application No. PCT/JP2024/042310, filed on Nov. 29, 2024.

(30) Foreign Application Priority Data
Dec. 7, 2023 (JP) 2023-207009

(51) Int. Cl. H05B 45/44

(52) U.S. Cl. CPC H05B 45/44

(57) ABSTRACT

A light-emitting element drive device includes: a voltage monitoring unit configured monitor a voltage at a connection terminal for each switch turned on and to hold the result of the monitoring; and a control signal generation unit configured to update, when the result of the monitoring for all light-emitting units is held, a control signal used for feedback control on a power supply voltage in a power supply circuit based on the result of the monitoring held.

### CROSS-REFERENCE TO RELATED APPLICATIONS

This nonprovisional application is a continuation application of International Patent Application No. PCT/JP2024/042310 filed on Nov. 29, 2024, which claims priority to Japanese Patent Application No. 2023-207009 filed on Dec. 7, 2023, the entire contents of which are hereby incorporated by reference.

### TECHNICAL FIELD

The present disclosure relates to light-emitting element drive devices.

### BACKGROUND ART

Conventionally, Patent Document 1 discloses a light-emitting element drive device which includes a plurality of channels of connection terminals to be connected to light-emitting units formed with one or more light-emitting elements, and is configured to be capable of supplying a drive current to the light-emitting unit via the connection terminal for each of the channels.

### RELATED ART DOCUMENT

### Patent Document

Patent Document 1: International Publication No. 2022/153668

### BRIEF DESCRIPTION OF DRAWINGS

FIG. 1 is a diagram showing the configuration of a light-emitting system according to an embodiment of the present disclosure;

FIG. 2 is a timing chart showing an example of a time division light emission operation;

FIG. 3 is a diagram showing a first embodiment of a configuration related to feedback control in a light-emitting element drive device;

FIG. 4 is a diagram showing the configuration of a constant current circuit;

FIG. 5 is a diagram showing a configuration related to feedback control in a variation of the first embodiment;

FIG. 6 is a diagram showing a second embodiment of the configuration related to feedback control;

FIG. 7 is a diagram showing a third embodiment of the configuration related to feedback control;

FIG. 8 is a diagram showing a fourth embodiment of the configuration related to feedback control;

FIG. 9 is a diagram showing an example of the configuration of a liquid crystal display device;

FIG. 10 is a diagram showing an example of an in-vehicle display;

FIG. 11 is a diagram showing the configuration of a light-emitting system in a first comparative example; and

FIG. 12 is a diagram showing the configuration of a light-emitting system in a second comparative example.

### DESCRIPTION OF EMBODIMENTS

Exemplary embodiments of the present disclosure will be described below with reference to drawings.

### First Comparative Example

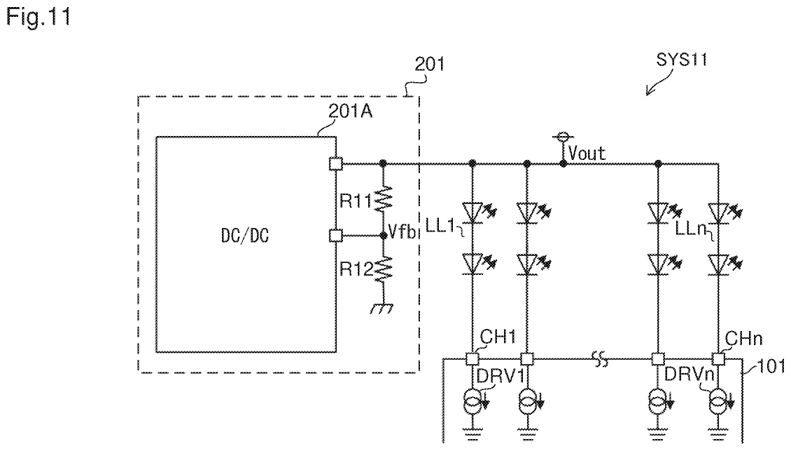

Before the description of the embodiments of the present disclosure, comparative examples will be described for comparison. FIG. 11 is a diagram showing the configuration of a light-emitting system SYS11 in a first comparative example. The light-emitting system SYS11 includes a light-emitting element drive device 101, a power supply circuit 201 and light-emitting units LL1 to LLn.

The light-emitting element drive device 101 is a semiconductor device which is configured to be capable of driving the light-emitting units LL1 to LLn in a plurality of channels (n channels). Each of the light-emitting units LL1 to LLn includes one or more light-emitting elements. The light-emitting element is an LED (light-emitting diode) in the example shown in FIG. 11. In the following description, the LED is an example of the light-emitting element. In other words, the light-emitting element drive device functions as an LED drive device.

The light-emitting element drive device 101 includes connection terminals CH1 to CHn as external terminals for establishing electrical connection to the outside. The cathodes of the light-emitting units LL1 to LLn are connected to the connection terminals CH1 to CHn, respectively. The light-emitting element drive device 101 includes current drives DRV1 to DRVn. The current drives DRV1 to DRVn are connected to the connection terminals CH1 to CHn, respectively. The current drives DRV1 to DRVn respectively generate drive currents which flow through the light-emitting units LL1 to LLn via the connection terminals CH1 to CHn.

The power supply circuit 201 includes a DC/DC converter 201A and feedback resistors R11 and R12. The DC/DC converter 201A is a circuit for converting an input voltage which is an unillustrated direct-current voltage into a power supply voltage (output voltage) Vout which is a direct-current voltage. The feedback resistors R11 and R12 are connected in series between the application end of the power supply voltage Vout and a ground end (the application end of a ground potential), and divides the power supply voltage Vout to generate a feedback voltage Vfb. The DC/DC converter 201A controls the power supply voltage Vout such that the feedback voltage Vfb matches a predetermined reference voltage. The power supply voltage Vout is applied to each of the anodes of the light-emitting units LL1 to LLn.

The power supply voltage Vout is controlled to be a fixed voltage by the power supply circuit 201A. Here, the Vf (forward voltage) of each of the light-emitting units LL1 to LLn has a temperature characteristic in which the Vf is changed depending on the temperature, and even at the same temperature, a variation in the voltage value is caused. As the temperature is increased, the Vf is lowered. The Vf of the light-emitting unit LL is determined by the Vf of the light-emitting element (LED) of the light-emitting unit LL. For example, when the light-emitting unit LL is formed by connecting the four light-emitting elements in series, and the Vf of the light-emitting element is assumed to be Vf_LED, the Vf of the light-emitting unit LL is such that Vf=4×Vf_LED.

The setting value of the power supply voltage Vout is set with consideration given to the setting value Vset of each of terminal voltages at the connection terminals CH1 to CHn, the temperature characteristic of the Vf and the variation described above. Specifically, when the maximum value of the Vf is assumed to be Vf_Max, the Vout is set equal to or greater than Vf_Max+Vset. For example, when as described above, the light-emitting unit LL is formed by connecting the four light-emitting elements in series, and the maximum value of the Vf_LED is 3.3 V, Vf_Max=3.3×4, and when Vset=0.9 V, the Vout is set equal to or greater than 3.3×3+0.9=14. 1 V.

However, since the power supply voltage Vout is the fixed voltage, when the temperature is increased to lower the Vf, the terminal voltages at the connection terminals CH1 to CHn are increased, and thus a loss and heat generation in the light-emitting element drive device 101 are increased. For example, in the example described above, when it is assumed that Vf_Max=2.7×4=10.8 V holds true due to a high temperature, the terminal voltages at the connection terminals CH1 to CHn are 14.1−10.8=3.3 V, and when it is assumed that drive current=50 mA and number of channels=24, the loss is such that 3.3 V×50 mA×24=3.96 W. Here, a condition in which the Vf is the same in the channels is assumed to be satisfied. However, a variation in the Vf between the channels actually affects the loss.

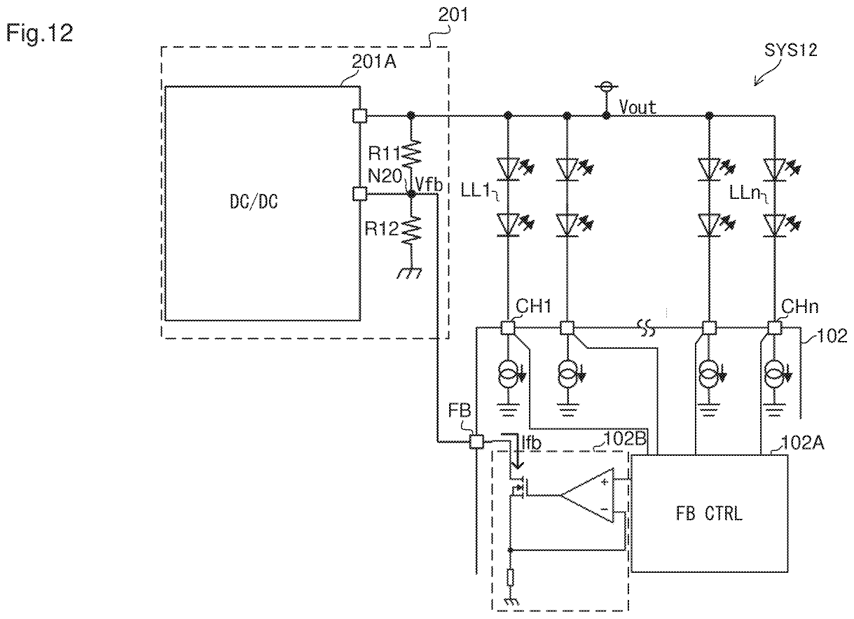

FIG. 12 is a diagram showing the configuration of a light-emitting system SYS12 in a second comparative example. The second comparative example differs from the first comparative example (FIG. 11) of the light-emitting system SYS12 in a light-emitting element drive device 102.

The light-emitting element drive device 102 differs from the light-emitting element drive device 101 (FIG. 11) in the first comparative example in that the light-emitting element drive device 102 includes a FB (feedback) control unit 102A, a FB current generation unit 102B and a FB terminal serving as an external terminal.

The FB control unit 102A monitors the terminal voltages at the connection terminals CH1 to CHn, and provides a current command value to the FB current generation unit 102B. The FB current generation unit 102B is configured as a constant current circuit to control a FB current Ifb to the current command value. The FB terminal is connected to a node N20 to which the feedback resistors R11 and R12 are connected. The FB current Ifb is extracted from the node N20 to flow through the FB current generation unit 102B via the FB terminal. The feedback voltage Vfb is generated according to the FB current Ifb.

The FB control unit 102A provides a command to the FB current generation unit 102B while constantly monitoring the terminal voltages at the connection terminals CH1 to CHn, and when all the terminal voltages are sufficient, the FB control unit 102A lowers the current command value to lower the power supply voltage Vout. On the other hand, when only one of the terminal voltages is insufficient, the FB control unit 102A increases the current command value to increase the power supply voltage Vout.

The control as described above is performed, and thus the terminal voltages at the connection terminals CH1 to CHn are controlled to the setting value Vset. Hence, the power supply voltage Vout is such that Vout=Vset+Vf, and the Vout is changed depending on the temperature. For example, when the Vf is the same in the channels, and it is assume that Vset=0.9 V, drive current=50 mA and number of channels=24, the loss does not depend on the temperature characteristic, with the result that the loss is such that 0.9 V×50 mA×24=1.08 W. In this way, the loss can be reduced as compared with the first comparative example.

However, in the second comparative example as described above, the FB control unit 102A provides a command to the FB current generation unit 102B while constantly monitoring the terminal voltages at the connection terminals CH1 to CHn, and when a larger number of channels are provided, it is likely that a ripple occurs in the power supply voltage Vout, and thus the power supply voltage Vout is instable.

### Configuration of Light-Emitting System

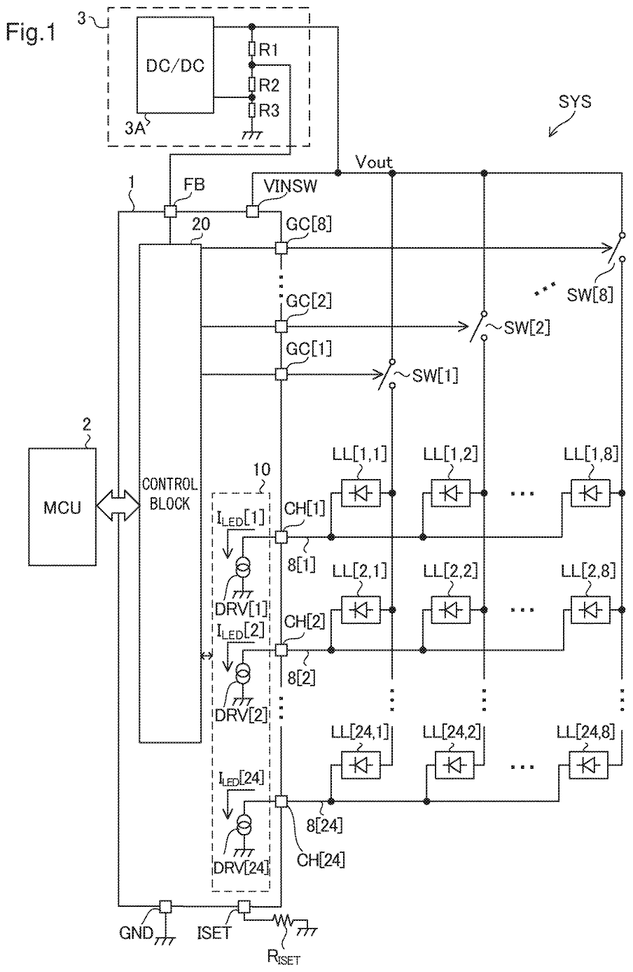

In view of the problems described above, the embodiment of the present disclosure which will be described below is performed. FIG. 1 is a diagram showing the configuration of a light-emitting system SYS according to the embodiment of the present disclosure.

The light-emitting system SYS includes a light-emitting element drive device 1, a MCU (Micro Controller Unit) 2 which controls the light-emitting element drive device 1, a plurality of light-emitting units LL which are driven by the light-emitting element drive device 1 and a power supply circuit 3 which outputs a power supply voltage Vout. The power supply voltage Vout is a positive direct-current voltage. The light-emitting element drive device 1 includes, as an external terminal, a terminal VINSW which receives the power supply voltage Vout, and is driven based on the power supply voltage Vout. A current setting resistor R_{ISET} is included in the constituent elements of the light-emitting system SYS.

When the plurality of light-emitting units provided in the light-emitting system SYS are not distinguished from each other, each of the light-emitting units is referred to as a light-emitting unit LL. The light-emitting unit LL includes one or more light-emitting elements (LEDs). For example, the light-emitting unit LL is formed with a series circuit of a plurality of light-emitting elements. However, the light-emitting unit LL may be formed with a parallel circuit of a plurality of light-emitting elements, and in the light-emitting unit LL, a series circuit of a plurality of light-emitting elements and a parallel circuit of a plurality of light-emitting elements may be provided. The light-emitting unit LL may be formed with a single light-emitting element. The light-emitting unit LL includes a high potential end (anode) and a low potential end (cathode), and the light-emitting element of the light-emitting unit LL has a forward direction extending from the high potential end to the low potential end.

Here, it is assumed that as the plurality of light-emitting units LL, a total of (24×8) light-emitting units LL are provided in the light-emitting system SYS, and the total of (24×8) light-emitting units LL are represented by the symbols “LL [1, 1] to LL [24, 8]”. Among the light-emitting units LL [1, 1] to LL [24, 8], any one light-emitting unit LL is expressed as a light-emitting unit LL [i, j] where i is an integer which satisfies “1≤i≤24” and j is an integer which satisfies “1≤j≤8”. In the light-emitting system SYS and the light-emitting element drive device 1, the first to twenty fourth channels are set, and the light-emitting units LL [i, 1] to LL [i, 8] belong to the i-th channel. The light-emitting units LL [1, 1] to LL [24, 8] can be classified into the first to eighth groups, and the light-emitting units LL [1, j] to LL [24, j] belong to the j-th group.

In the light-emitting element drive device 1, connection terminals CH [1] to CH [24] corresponding to the total number of channels are provided. The connection terminal CH [i] belongs to the i-th channel. The connection terminal CH [i] is the light-emitting unit connection terminal to which the light-emitting units LL [i, 1] to LL [i, 8] belonging to the i-th channel need to be connected. When the connection terminals CH [1] to CH [24] are not distinguished from each other, each of the connection terminals can be referred to as the connection terminal CH.

In the light-emitting system SYS, switches SW [1] to SW [8] corresponding to the total number of groups are provided. The switch SW [j] is a switch which corresponds to the j-th group. One ends of the switches SW [1] to SW [8] are connected together to the application end of the power supply voltage Vout. The other end of the switch [j] is connected to each of the high potential ends of the light-emitting units LL [1, j] to LL [24, j] belonging to the j-th group. The low potential ends of the light-emitting units LL [i, 1] to LL [i, 8] belonging to the i-th channel are connected together to a wire 8 [i]. The wire 8 [i] is connected to the connection terminal CH [i].

The light-emitting element drive device 1 includes a driver block 10 and a control block 11. The driver block 10 includes current drivers DRV [1] to DRV [24]. The current driver DRV [i] belongs to the i-th channel. In other words, in the driver block 10, the current driver is provided for each of the channels. When a total of 24 current drivers which are respectively provided for the drivers are not distinguished from each other, each of the current drivers can be referred to as the current driver DRV. The configurations and functions of the current drivers DRV [1] to DRV [24] are the same as each other. In each of the channels, the current driver DRV [i] includes a constant current circuit, and in a normal light emission operation, the current driver DRV [i] is operated under the control of the control block 11 such that a drive current I_{LED} [i] flows from the connection terminal CH [i] toward the ground end. A drive current I_{LED} [1] flows through the light-emitting unit LL [1, j] via the connection terminal CH [1], and thus the light-emitting unit LL [1, j] emits light whereas a drive current I_{LED} [2] flows through the light-emitting unit LL [2, j] via the connection terminal CH [2], and thus the light-emitting unit LL [2, j] emits light. The same is true for the other drive currents and the other light-emitting units.

The control block 11 comprehensively controls the operations of the constituent elements in the light-emitting element drive device 1. In the light-emitting element drive device 1, terminals GC [1] to GC [8] which are connected to the control terminals of the switches SW [1] to SW [8] are provided as external terminals. The control block 11 can individually turn on or off the switches SW [1] to SW [8] through the terminals GC [1] to GC [8]. As each of the switches SW [1] to SW [8], for example, a P-channel MOSFET (metal-oxide-semiconductor field-effect transistor) can be used. Preferably, in this case, the power supply voltage Vout is supplied to the sources of the MOSFETs serving as the switches SW [1] to SW [8], the drain of the MOSFET serving as the switch SW [j] is connected to each of the high potential ends of the light-emitting units LL [1, j] to LL [24, j] and the control block 11 controls the gate voltages of the MOSFETs serving as the switches SW [1] to SW [8] through the terminals GC [1] to GC [8]. The control block 11 has the function of adjusting, in the normal light emission operation, the power supply voltage Vout output from the power supply circuit 3 based on the terminal voltages of the connection terminals CH [1] to CH [24] through a terminal FB (feedback terminal). The feedback control as described above will be described in detail later.

The light-emitting element drive device 1 and the MCU 2 can perform two-way communication via communication wiring. By the two-way communication, the MCU 2 can transmit any command to the light-emitting element drive device 1, and the light-emitting element drive device 1 can transmit, to the MCU 2, a response signal to the received command. A communication method between the light-emitting element drive device 1 and the MCU 2 is not limited, and may be, for example, a method which complies with SPI (Serial Peripheral Interface).

In the light-emitting element drive device 1, a terminal GND and a terminal ISET are also provided as external terminals. The terminal GND is connected to the ground end. The current setting resistor R_{ISET} is provided outside the light-emitting element drive device 1. One end of the current setting resistor R_{ISET} is connected to the terminal ISET, and the other end of the current setting resistor R_{ISET} is connected to the ground end. The control block 11 can individually set the magnitudes of the drive currents I_{LED} [1] to I_{LED} [24] based on the value of the current setting resistor R_{ISET} and a command from the MCU 2.

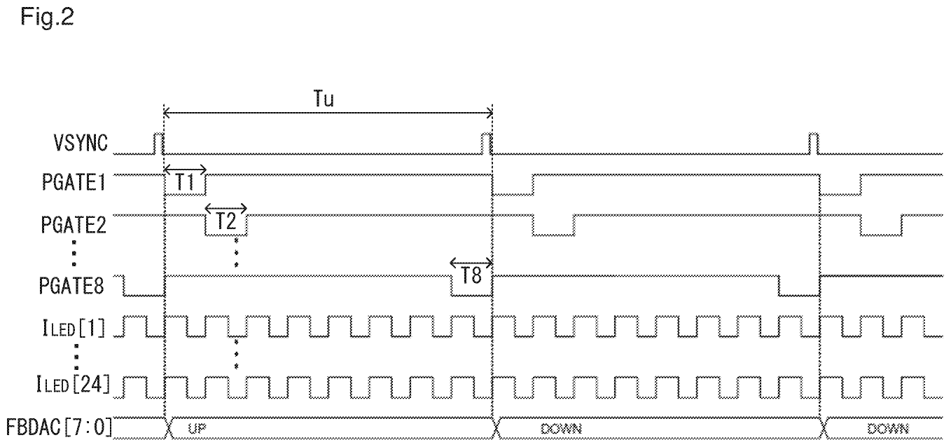

With reference to FIG. 2, a time division light emission operation which is one type of normal light emission operation will be described. FIG. 2 is a timing chart showing an example of the time division light emission operation. FIG. 2 shows, sequentially from above, examples of waveforms of a synchronization signal VSYNC, gate voltages PGATE1 to PGATE8 of the switches SW[1] to SW[8], the drive currents I_{LED} [1] to I_{LED} [24] and DAC (DA converter) data FBDAC. The DAC data FBDAC will be described later. The switch SW is assumed to be formed with a P-channel MOSFET.

In the time division light emission operation, a unit period Tu which has a predetermined time length is set. The unit period Tu is repeatedly set at a predetermined period. Furthermore, the unit period Tu is divided into eight portions, and thus first to eighth division periods T1 to T8 are set. In each of the first to eighth division periods T1 to T8, the control block 11 switches each of the gate voltages PGATE1 to PGATE8 low, and turns on each of the switches SW[1] to SW[8]. In other words, in the j-th division period, among the switches SW[1] to SW[8], only the switch SW [j] is turned on, and the other seven switches are turned off (the gate voltage PGATE is switched high). Hence, in the j-th division period, among the first to eighth groups, the power supply voltage Vout is supplied to only the high potential ends of the light-emitting units LL [1, j] to LL [24, j] in the j-th group via switch SW [j], and thus only the light-emitting units LL [1, j] to LL [24, j] can emit light.

In each of the first to eighth division periods T1 to T8, the control block 11 PWM-drives the current driver DRV for each of the channels. PWM is an abbreviation for pulse width modulation. In the PWM drive in each of the division periods, a time width (that is, a time length) during which the drive current I_{LED} [i] is supplied is controlled for each of the channels. In other words, the time widths during which the drive currents I_{LED} [1] to I_{LED} [24] are supplied are PWM-controlled on an individual basis. In this way, in each of the division periods, the corresponding light-emitting unit LL emits pulsed light, and the average brightness of the total of (24×8) light-emitting units LL is individually adjusted through the control of the time widths described above.

For example, when a light-emitting block formed with the light-emitting units LL [1, 1] t o LL [24, 8] is used as a light source for a display panel (display screen) such as a liquid crystal display panel, the unit period Tu may be set in synchronization with a vertical synchronization signal externally supplied to the light-emitting element drive device 1. In this case, the unit period Tu is repeatedly set at the period of the vertical synchronization signal. Then, the entire display region of the display panel is divided into a plurality of division regions (for example, (24×8) division regions), and the light-emitting units LL are assigned to the division regions. Then, the light emission brightness of the corresponding light-emitting units LL is adjusted according to the brightness of a video to be displayed in the division regions, and thus it is possible to perform local dimming (local light control) for the total number of division regions. By the local dimming, it is possible to enhance contrast in the video and to reduce power consumption.

### First Embodiment

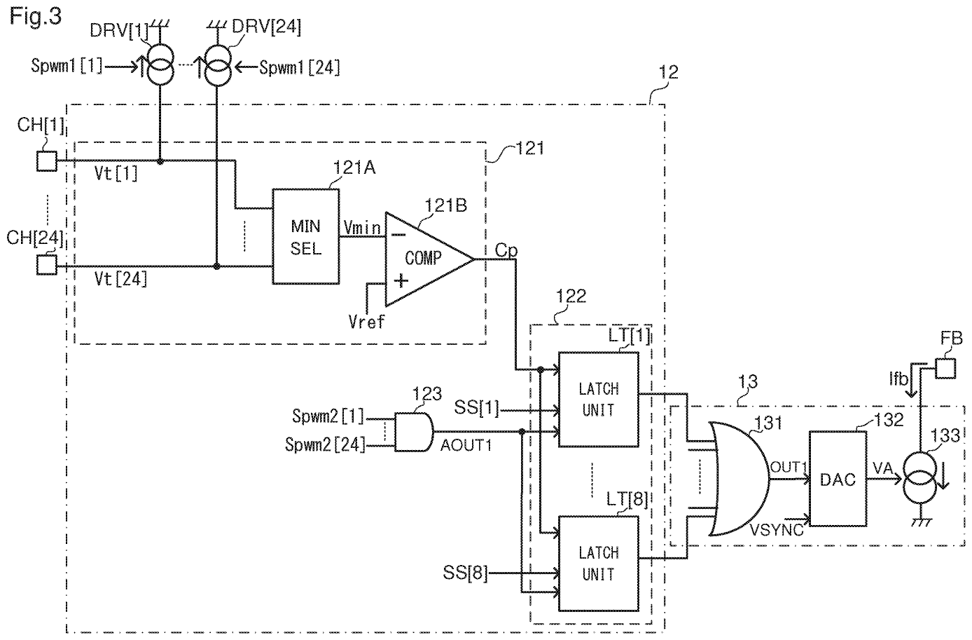

Various forms of the feedback control of the power supply voltage Vout in the light-emitting element drive device 1 according to the embodiment of the present disclosure will be described. FIG. 3 is a diagram showing a first embodiment of a configuration related to the feedback control in the light-emitting element drive device 1.

In the configuration shown in FIG. 3, in the control block 11 of the light-emitting element drive device 1, a voltage monitoring unit 12 and a FB control signal generation unit 13 are provided. The voltage monitoring unit 12 monitors terminal voltages Vt [1] to Vt [24] at the connection terminals CH [1] to CH [24], and holds the result of the monitoring.

The voltage monitoring unit 12 includes a minimum voltage determination unit 121 and a latch block 122. The minimum voltage determination unit 121 includes a minimum voltage selection unit 121A and a comparator 121B. The minimum voltage selection unit 121A selects the minimum voltage from among the terminal voltages Vt to Vt [24], and outputs a minimum voltage Vmin. The comparator 121B compares the minimum voltage Vmin with a reference voltage Vref, and outputs a comparison output Cp as the result of the comparison. The minimum voltage Vmin is applied to the inverting input terminal (−) of the comparator 121B, and the reference voltage Vref is applied to the non-inverting input terminal (+). In this way, when the minimum voltage Vmin is equal to or greater than the reference voltage Vref, the comparison output Cp is low whereas when the minimum voltage Vmin is less than the reference voltage Vref, the comparison output Cp is high. The reference voltage Vref corresponds to a setting value for the terminal voltages Vt [1] to Vt [24].

The latch block 122 includes latch units LT [1] to LT [8]. The latch units LT [1] to LT [8] correspond to the first to eighth groups. The comparison output Cp is input to each of the latch units LT [1] to LT [8]. Switch signals SS [1] to SS [8] are input to the latch units LT [1] to LT [8], respectively. The switch signals SS [1] to SS [8] are signals which individually indicate the turning on and off of the switch signals SS [1] to SS [8]. When the switch SW is on, the switch signal SS is at an on-level (for example, is high) whereas when the switch SW is off, the switch signal SS is at an off-level (for example, is low). In other words, when a gate signal PGATEj (FIG. 2) is low, the switch signal SS [j] is at an on-level whereas when the gate signal PGATEj is high, the switch signal SS [j] is at an off-level.

In the voltage monitoring unit 12, an AND circuit 123 is provided. PMW signals Spwm2 [1] to Spwm2 [24] are input to the AND circuit 123. The PMW signals Spwm2 [1] to Spwm2 [24] correspond to the first to twenty fourth channels. Here, as shown in FIG. 1 described above, the current drivers DRV [1] to DRV [24] are provided to correspond to the first to twenty fourth channels. The current drivers DRV [1] to DRV [24] are PWM-controlled by PMW signals Spwm1 [1] to Spwm1 [24], respectively. The PMW signals Spwm2 [1] to Spwm2 [24] are synchronized with the PMW signals Spwm1 [1] to Spwm1 [24], respectively. In other words, when the PMW signals Spwm1 [1] to Spwm1 [24] are high, the PMW signals Spwm2 [1] to Spwm2 [24] are high whereas when the PMW signals Spwm1 [1] to Spwm1 [24] are low, the PMW signals Spwm2 [1] to Spwm2 [24] are low. When the PMW signals Spwm1 [1] to Spwm1 [24] are high, the current drivers DRV to DRV [24] supply the drive currents whereas when the PMW signals Spwm1 [1] to Spwm1 [24] are low, the supply of the drive currents performed by the current drivers DRV [1] to DRV [24] is stopped. The PMW signals Spwm1 [1] to Spwm1 [24] and the PMW signals Spwm2 [1] to Spwm2 [24] may be the same as or different from each other.

The FB control signal generation unit 13 includes an OR circuit 131, a DAC 132 and a constant current circuit 133. The outputs of the latch units LT [1] to LT [8] are input to the OR circuit 131. The OR circuit 131 performs the logical sum of the outputs of the latch units LT [1] to LT [8], and outputs the result to the DAC 132 as an output OUT1. The DAC 132 sets DAC data (digital value) (the FBDAC in FIG. 2) according to the output OUT1 of the OR circuit 131, converts the set DAC data into an analog voltage VA and outputs the analog voltage VA to the constant current circuit 133. In the example shown in FIG. 2, the DAC data FBDAC is assumed to be 8-bit data as an example. Although the synchronization signal VSYNC (FIG. 2) is input to the DAC 132, this operation will be described later.

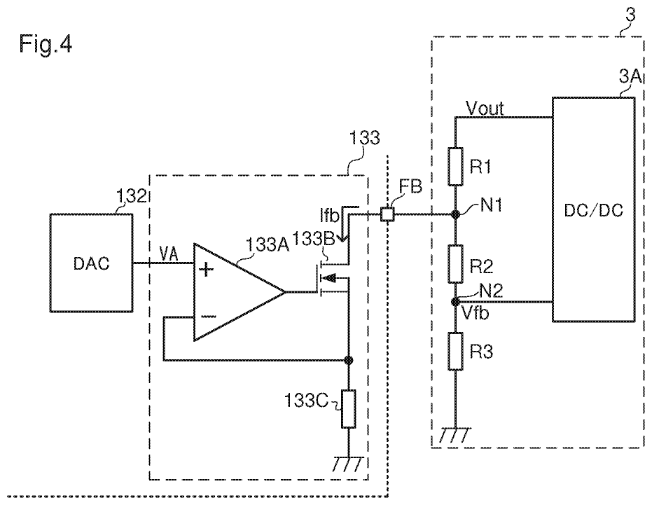

The constant current circuit 133 generates the FB current Ifb which is a constant current according to the analog voltage VA serving as the current command value. The FB current Ifb flows via the terminal FB. Here, FIG. 4 is a diagram showing the configuration of the constant current circuit 133. The constant current circuit 133 includes an error amplifier 133A, an output transistor 133B and a resistor 133C. The analog voltage VA output from the DAC 132 is applied to the non-inverting input terminal (+) of the error amplifier 133A. The output end of the error amplifier 133A is connected to the gate of the output transistor 133B formed with an N-channel MOSFET. The source of the output transistor 133B is connected to one end of the resistor 133C together with the inverting input terminal (−) of the error amplifier 133A. The ground end is connected to the other end of the resistor 133C. The drain of the output transistor 133B is connected to the terminal FB.

As shown in FIG. 4, the power supply circuit 3 (also shown in FIG. 1) includes a DC/DC converter 3A and feedback resistors R1 to R3. The feedback resistors R1 to R3 are connected in series between the application end of the power supply voltage Vout output from the DC/DC converter 3A and the ground end. Specifically, the application end of the power supply voltage Vout is connected to one end of the feedback resistor R1. The other end of the feedback resistor R1 is connected to one end of the feedback resistor R2 at a node N1. The other end of the feedback resistor R2 is connected to one end of the feedback resistor R3 at a node N2. The other end of the feedback resistor R3 is connected to the ground end. The node N1 is connected to the terminal FB. In the configuration as described above, the FB current Ifb generated by the constant current circuit 133 according to the analog voltage VA is extracted from the node N1 via the terminal FB. The feedback voltage Vfb is generated at the node N2 according to the FB current Ifb. The DC/DC converter 3A controls the power supply voltage Vout such that the feedback voltage Vfb matches a predetermined reference voltage.

Here, in the latch block 122 shown in FIG. 3, each of the latch units LT [1] to LT [8] receives and holds the comparison output Cp when each of the switch signals SS [1] to SS [8] is high, and the output AOUT1 of the AND circuit 123 is high. When each of the switch signals SS [1] to SS [8] is low, or the output AOUT1 is low, the received signal is held. In other words, when the switch SW [j] is on, and the drive currents are supplied in all the channels from the first channel to the twenty fourth channel, the signal is received by the latch unit LT [j]. Since the comparison output Cp is a logic signal which can be high or low, the signal held by the latch unit LT can also be high or low.

The signal received and held in each of the latch units LT [1] to LT [8] is input to the OR circuit 131. When the output OUT1 of the OR circuit 131 is low, this indicates that the comparison output Cp is low in all the first to eighth groups. In other words, it is detected that the minimum voltage Vmin among the terminal voltages Vt [1] to Vt [24] for the 24 channels is equal to or greater than the reference voltage Vref in all the first to eighth groups, and this indicates that the terminal voltages Vt are sufficient for all the light-emitting units LL which correspond in number to (24 channels×8 groups).

On the other hand, when the output OUT1 of the OR circuit 131 is high, this indicates that the comparison output Cp is high in at least one of the first to eighth groups. In other words, it is detected that the minimum voltage Vmin among the terminal voltages Vt [1] to Vt [24] for the 24 channels is less than the reference voltage Vref in at least one of the first to eighth groups, and this indicates that the terminal voltage Vt is insufficient for at least one of the light-emitting units LL which correspond in number to (24 channels×8 groups).

Here, the operation will be described with reference to FIG. 2. When the unit period Tu is started, the switch SW [1] in the first group is turned on, and thus a first period T1 is started, with the result that PWM control is performed on the drive currents I_{LED} [1] to I_{LED} [24] for the 24 channels. In the first period T1, the comparison output Cp is received and held by the latch unit LT [1]. After the first period T1, the switch SW [2] in the second group is turned on, and thus a second period T2 is started. During the second period T2, the comparison output Cp is received and held by the latch unit LT [2]. Thereafter, the comparison output Cp is likewise received and held until an eighth period T8. When the synchronization signal VSYNC is raised and then dropped, the subsequent unit period Tu is started.

The DAC 132 updates the DAC data according to the output OUT1 when the synchronization signal VSYNC is raised and then dropped. Specifically, when the output OUT1 is low, the DAC data is updated in a direction in which the analog voltage VA is lowered. When the output OUT1 is high, the DAC data is updated in a direction in which the analog voltage VA is raised. When the DAC data is updated, the value of the FB current Ifb is updated. Thereafter, the same operation is repeated every unit period Tu.

Hence, when the terminal voltages Vt are sufficient for all the light-emitting units LL which correspond in number to (24 channels×8 groups), the control is performed in the direction in which the power supply voltage Vout is lowered whereas when the terminal voltage Vt is insufficient for at least one of the light-emitting units LL, the control is performed in the direction in which the power supply voltage Vout is increased. In this way, the terminal voltages Vt are controlled to be equal to or greater than the setting value for all the light-emitting units LL which correspond in number to (24 channels×8 groups). Since the terminal voltages Vt are controlled to be equal to or greater than the setting value without depending on the temperature, the loss can be suppressed.

In particular, in the present embodiment, during the unit period Tu, all the light-emitting units LL which correspond in number to (24 channels×8 groups) are monitored, and after the result of the monitoring is held, when the subsequent unit period Tu is started, the value of the FB current Ifb for controlling the power supply voltage Vout is updated, with the result that the occurrence of a ripple in the power supply voltage Vout is suppressed, and thus it is possible to enhance the stability of the power supply voltage Vout.

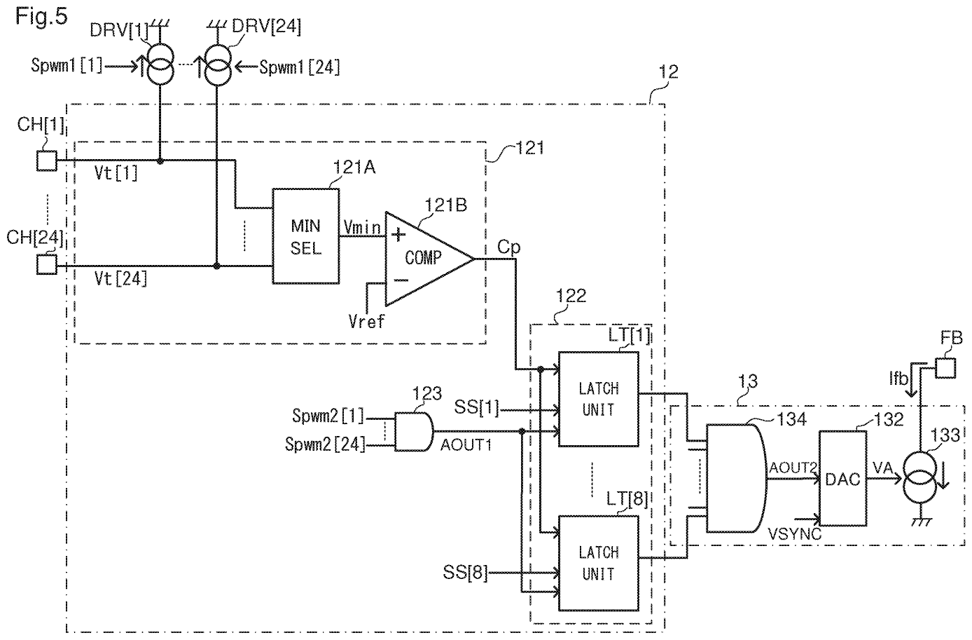

FIG. 5 is a diagram showing a configuration related to feedback control in a variation of the first embodiment. The configuration shown in FIG. 5 differs from the configuration in the first embodiment in that the polarity of the input terminal of the comparator 121B is reversed, and the OR circuit 131 in the FB control signal generation unit 13 is replaced with an AND circuit 134.

The signal received and held in each of the latch units LT [1] to LT [8] is input to the AND circuit 134. When the output AOUT2 of the AND circuit 134 is high, this indicates that the comparison output Cp is high in all the first to eighth groups. In other words, it is detected that the minimum voltage Vmin among the terminal voltages Vt [1] to Vt [24] for the 24 channels is equal to or greater than the reference voltage Vref in all the first to eighth groups, and this indicates that the terminal voltages Vt are sufficient for all the light-emitting units LL which correspond in number to (24 channels×8 groups).

On the other hand, when the output AOUT2 of the AND circuit 134 is low, this indicates that the comparison output Cp is low in at least one of the first to eighth groups. In other words, it is detected that the minimum voltage Vmin among the terminal voltages Vt [1] to Vt [24] for the 24 channels is less than the reference voltage Vref in at least one of the first to eighth groups, and this indicates that the terminal voltage Vt is insufficient for at least one of the light-emitting units LL which correspond in number to (24 channels×8 groups).

When the output AOUT2 is high, the DAC 132 updates the DAC data in the direction in which the analog voltage VA is lowered. When the output AOUT2 is low, the DAC 132 updates the DAC data in the direction in which the analog voltage VA is raised. In the variation as described above, the same effects as in the first embodiment are achieved.

### Second Embodiment

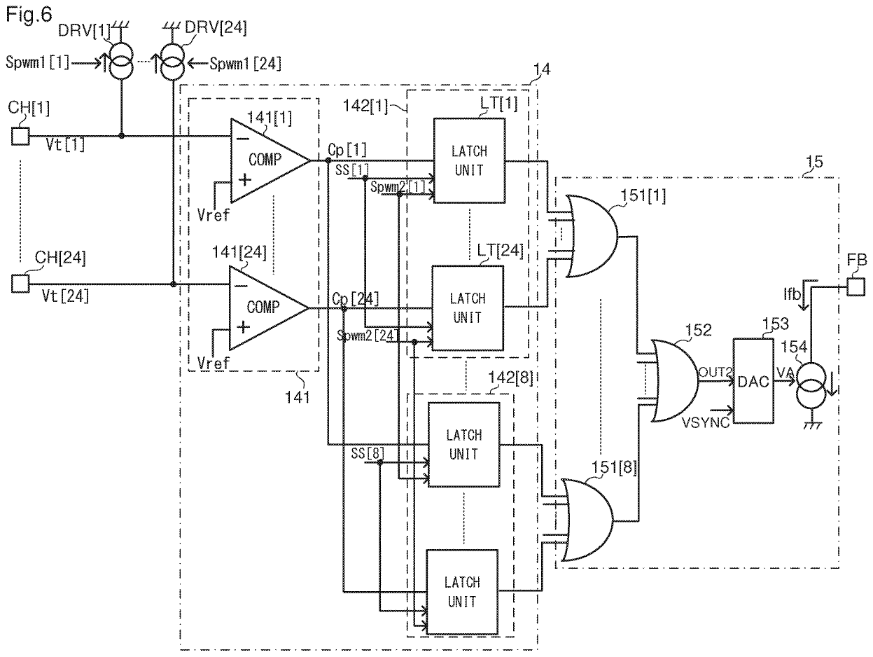

FIG. 6 is a diagram showing a second embodiment of the configuration related to feedback control. In the configuration shown in FIG. 6, in the control block 11, a voltage monitoring unit 14 and a FB control signal generation unit 15 are provided.

The voltage monitoring unit 14 includes a comparison block 141 and latch blocks 142 [1] to 142 [8]. The comparison block 141 includes comparators 141 [1] to 141 [24]. The comparators 141 [1] to 141 [24] correspond to the first to twenty fourth channels, respectively. The comparators 141 [1] to 141 [24] compare the terminal voltages Vt [1] to Vt [24] with the reference voltage Vref to output comparison outputs Cp [1] to Cp [24], respectively. The terminal voltages Vt [1] to Vt [24] are applied to the inverting input terminals of the comparators 141 [1] to 141 [24], and the reference voltage Vref is applied to the non-inverting input terminals of the comparators 141 [1] to 141 [24].

The latch blocks 142 [1] to 142 [8] correspond to the first to eighth groups, respectively. Each of the latch blocks 142 [1] to 142 [8] includes latch units LT [1] to LT [24]. The latch units LT [1] to LT [24] correspond to the first to twenty fourth groups, respectively.

A comparison output Cp [i] is input to the latch unit LT [i] in each of the latch blocks 142 [1] to 142 [8]. The switch signal SS [j] is input to the latch units LT [1] to LT [24] in the latch block 142 [j]. A PWM signal Spwm 2 [i] is input to the latch unit LT [i] in each of the latch blocks 142 [1] to 142 [8].

When the switch signal SS [j] is switched high (that is, the switch SW [j] is turned on), and the PWM signal Spwm2 [i] is switched high (that is, the drive current I_{LED} [i] is supplied), the latch unit LT [i] in the latch block 142 [j] receives and holds the comparison output Cp [i]. In this way, in the example shown in FIG. 2, during each of the time division periods T1 to T8, the comparison output is received and held by the latch blocks 142 [1] to 142 [8].

The FB control signal generation unit 15 includes OR circuits 151 [1] to 151 [8], an OR circuit 152, a DAC 153 and a constant current circuit 154. The signals held by the latch units LT [1] to LT [24] in the latch block 142 [j] are input to the OR circuit [j]. The outputs of the OR circuits 151 [1] to 151 [8] are input to the OR circuit 152. The OR circuit 152 outputs the output OUT2 to the DAC 153.

When the output OUT2 is low, this indicates that all the comparison outputs Cp for (24 channels×8 groups) held by the latch blocks 142 [1] to 142 [8] are low. In other words, this indicates that the terminal voltages Vt are sufficient for all the light-emitting units LL which correspond in number to (24 channels×8 groups).

On the other hand, when the output OUT2 is high, this indicates that at least one of the comparison outputs Cp for (24 channels×8 groups) held by the latch blocks 142 [1] to 142 [8] are high. In other words, this indicates that the terminal voltage Vt is insufficient for at least one of the light-emitting units LL which correspond in number to (24 channels×8 groups).

When the output OUT2 is low, the DAC 153 updates the DAC data in the direction in which the analog voltage VA is lowered. When the output OUT2 is high, the DAC 153 updates the DAC data in the direction in which the analog voltage VA is raised. In the present embodiment as described above, the same effects as in the first embodiment are also achieved. However, in terms of the circuit area, the first embodiment is advantageous.

In the present embodiment, when the polarities of the input terminals of the comparators 141 [1] to 141 [24] are reversed, the OR circuits 151 [1] to 151 [8] and the OR circuit 152 may be replaced by AND circuits.

### Third embodiment

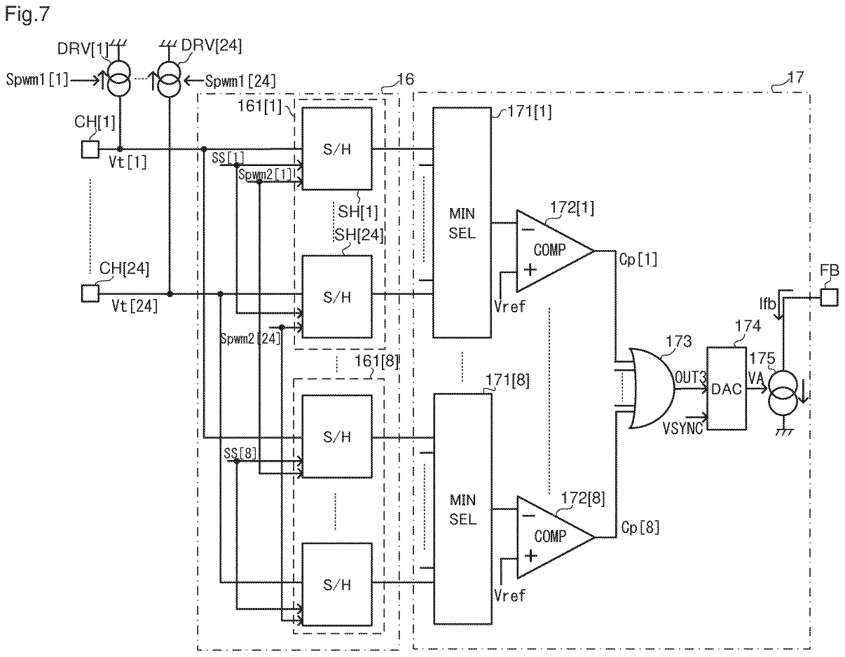

FIG. 7 is a diagram showing a third embodiment of a configuration related to feedback control. In the configuration shown in FIG. 7, in the control block 11, a voltage monitoring unit 16 and a FB control signal generation unit 17 are provided.

The voltage monitoring unit 16 includes sample-and-hold blocks (hereinafter SH blocks) 161 [1] to 161 [8]. Each of the sample-and-hold blocks 161 [1] to 161 [8] includes sample-and-hold units SH [1] to SH [24].

The SH blocks 161 [1] to 161 [8] correspond to the first to eighth groups, respectively. The sample-and-hold units SH [1] to SH [24] correspond to the first to twenty fourth channels, respectively.

The terminal voltage Vt [i] is input to the sample-and-hold unit SH [i] in each of the SH blocks 161 [1] to 161 [8]. The switch signal SS [j] is input to the sample-and-hold units SH [1] to SH [24] in the SH block 161 [j]. The PWM signal Spwm2 [i] is input to the sample-and-hold unit SH [i] in each of the SH blocks 161 [1] to 161 [8].

When the switch signal SS [j] is switched high (that is, the switch SW [j] is turned on), and the PWM signal Spwm2 [i] is switched high (that is, the drive current I_{LED} [i] is supplied), the sample-and-hold unit SH [i] in the SH block 161 [j] starts to sample the terminal voltage Vt [i]. Then, when the PWM signal Spwm2 [i] is switched low (that is, is brought into a state where the supply of the drive current I_{LED} [i] is stopped), the sample-and-hold unit SH [i] holds the terminal voltage Vt [i] sampled immediately before. In this way, in the example shown in FIG. 2, during each of the time division periods T1 to T8, the terminal voltage Vt is sampled and held by the SH blocks 161 [1] to 161 [8].

The FB control signal generation unit 17 includes minimum voltage selection units 171 [1] to 171 [8], comparators 172 [1] to 172 [8], an OR circuit 173, a DAC 174 and a constant current circuit 175.

The voltages held by the sample-and-hold units SH [1] to SH [24] in the SH block 161 [j] are input to the minimum voltage selection unit 171 [j]. The minimum voltage selection unit 171 [j] selects and outputs the minimum voltage among the input voltages. The comparator 172 [j] compares the voltage output from the minimum voltage selection unit 171 [j] with the reference voltage Vref to output the comparison output Cp [j]. The comparison outputs Cp [1] to Cp [8] are input to the OR circuit 173. The OR circuit 173 outputs an output OUT3 to the DAC 174.

When the output OUT3 is low, this indicates that all the comparison outputs Cp to Cp [8] are low, and all the voltages output from the minimum voltage selection units 171 [1] to 171 [8] are equal to or greater than the reference voltage Vref. In other words, this indicates that all the terminal voltages Vt for (24 channels×8 groups) are equal to or greater than the setting value.

On the other hand, when the output OUT3 is high, this indicates that at least one of the comparison outputs Cp [1] to Cp [8] are high, and at least one of the voltages output from the minimum voltage selection units 171 [1] to 171 [8] are less than the reference voltage Vref. In other words, this indicates that at least one of the terminal voltages Vt for (24 channels×8 groups) are less than the setting value.

When the output OUT3 is low, the DAC 174 updates the DAC data in the direction in which the analog voltage VA is lowered. When the output OUT3 is high, the DAC 174 updates the DAC data in the direction in which the analog voltage VA is raised. In the present embodiment as described above, the same effects as in the first embodiment are also achieved. As described above, the result of the monitoring held by the voltage monitoring unit is not limited to a logic signal such as an output of a comparator, and may be a terminal voltage as in the present embodiment.

In the present embodiment, when the polarities of the input terminals of the comparators 172 [1] to 172 [8] are reversed, the OR circuit 173 may be replaced by an AND circuit.

### Fourth Embodiment

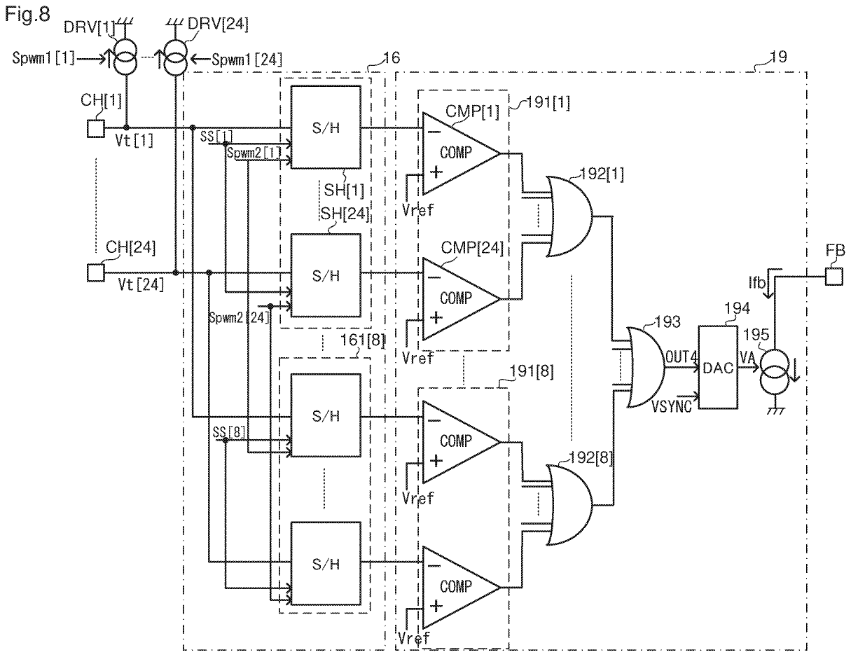

FIG. 8 is a diagram showing a fourth embodiment of the configuration related to feedback control. The fourth embodiment differs from the third embodiment in the present embodiment in a FB control signal generation unit 19.

The FB control signal generation unit 19 includes comparison blocks 191 [1] to 191 [8], OR circuits 192 [1] to 192 [8], an OR circuit 193, a DAC 194 and a constant current circuit 195.

Each of the comparison blocks 191 [1] to 191 [8] includes comparators CMP [1] to CMP [24]. The comparator CMP [i] in the comparison block 191 [j] compares the voltage output from the sample-and-hold unit SH [i] in the SH block [j] with the reference voltage Vref. The outputs of the comparators CMP [1] to CMP [24] in the comparison block 191 [j] are input to the OR circuit 192 [j]. The outputs of the OR circuits 192 [1] to 192 [8] are input to the OR circuit 193. The OR circuit 193 outputs an output OUT4 to the DAC 194.

When the output OUT4 is low, this indicates that all the outputs of the comparators CMP [1] to CMP [24] in the comparison blocks 191 [1] to 191 [8] are low, and all the terminal voltages Vt for (24 channels×8 groups) are equal to or greater than the setting value.

On the other hand, when the output OUT4 is high, this indicates that at least one of the comparators CMP [1] to CMP [24] in the comparison blocks 191 [1] to 191 [8] are high, and at least one of the terminal voltages Vt for (24 channels×8 groups) are less than the setting value.

When the output OUT4 is low, the DAC 194 updates the DAC data in the direction in which the analog voltage VA is lowered. When the output OUT4 is high, the DAC 194 updates the DAC data in the direction in which the analog voltage VA is raised. In the present embodiment as described above, the same effects as in the first embodiment are also achieved. However, in terms of the circuit area, the third embodiment is advantageous.

In the present embodiment, when the polarities of the input terminals of the comparators CMP [1] to CMP [24] are reversed, the OR circuits 192 [1] to 192 [8] and the OR circuit 193 may be replaced by AND circuits.

### Application to Liquid Crystal Display Device (LCD)

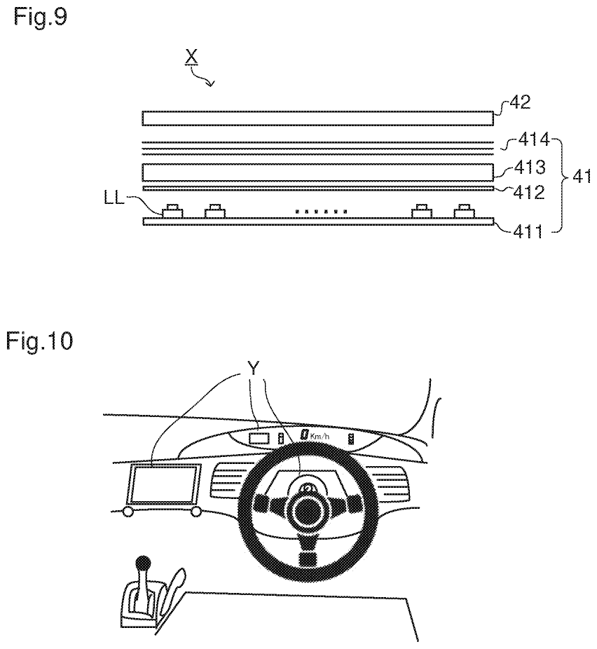

As an example of a target to which the light-emitting element drive devices according to the embodiments described above are applied, a liquid crystal display device will be described. An example of the configuration of the liquid crystal display device is shown in FIG. 9. The configuration shown in FIG. 9 is a so-called direct-type configuration.

The liquid crystal display device X shown in FIG. 9 includes a backlight 41 and a liquid crystal panel 42. The backlight 41 is an illumination device (an example of a light-emitting device) which illuminates the liquid crystal panel 42 from behind. The backlight 41 includes a light source unit 411, a phosphor sheet 412, a diffusion plate 413 and optical sheets 414.

The light source unit 411 includes the light-emitting units LL (FIG. 1) and a substrate on which the light-emitting units are mounted, and as a light-emitting element drive device for driving the light-emitting units LL, the light-emitting element drive device in each of the embodiments described above can be used. The light-emitting units LL emit blue light (single color) as an example. The phosphor sheet 412 transmits a part of the blue light from the light source unit 411, and absorbs another part of the blue light to emit yellow light. In the backlight 41, monochromatic light-emitting units LL is combined with the phosphor sheet 412 to emit synthesized white light. The diffusion plate 413 provides a diffusion effect to the light from phosphor sheet 412. The optical sheets 414 provide a predetermined optical effect to the light from the diffusion plate 413, and emit the resulting light toward the liquid crystal panel 42.

The light-emitting units LL are arranged in a matrix according to divided display regions in the liquid crystal panel 42. Each of the light-emitting units LL is PWM-driven, and thus the brightness thereof is adjusted, with the result that local dimming can be performed.

### About In-Vehicle Display

The liquid crystal display device to which the light-emitting element drive device according to each of the embodiments described above is applied is particularly suitable for application to an in-vehicle display. The in-vehicle display is provided on a dashboard in front of the driver's seat of a vehicle, for example, as in an in-vehicle display Y shown in FIG. 10. The in-vehicle display Y displays various types of images such as images of car navigation information, captured images of the rear of the vehicle, a speedometer, a tachometer, a fuel gauge, a fuel consumption meter and a shift position, and thereby can provide various types of information to a user.

Although the size of the screen of the in-vehicle display is being increased, the light-emitting element drive device according to each of the embodiments described above itself can control a large number of light-emitting units (division display regions), and thus it is possible to significantly reduce the number of light-emitting element drive devices installed and the mounting area.

### Others

In various technical features disclosed in the present specification, in addition to the embodiments described above, various changes can be added without departing from the spirit of the technical creation. In other words, it should be considered that the embodiments described above are illustrative in all respects, and not restrictive. It should be understood that the technical scope of the present invention is not limited to the embodiments described above and includes meanings equivalent to the scope of claims and all changes in the scope.

For example, although the FB control signal generated by the FB control signal generation unit in the embodiments described above is the FB current extracted from the node to which the feedback resistor in the power supply circuit is connected, the FB control signal is not limited to the FB current, and may be, for example, a control signal or the like capable of changing the reference voltage for comparison with the feedback voltage in the DC/DC converter.

### Additional Remarks

As described above, a light-emitting element drive device (1) according to an aspect of the present disclosure is a light-emitting element drive device used in a light-emitting system (SYS) in which at least one channel of light-emitting units (LL) each including at least one light-emitting element are provided, and a plurality of groups including the at least one channel of light-emitting units are provided, and the light-emitting element drive device includes: a connection terminal (CH) configured to be connectable to low potential ends of the at least one channel of light-emitting units; a switch control unit (20) configured to be capable of controlling turning on and off of a switch (SW) connected between high potential ends of the light-emitting units in each of the plurality of groups and an application end to which a power supply voltage (Vout) output from a power supply circuit (3) is applied; a current driver (DRV) configured to supply a drive current (I_{LED}) to the light-emitting units via the connection terminal; a voltage monitoring unit (12) configured to monitor a voltage at a corresponding one of connection terminals each being the connection terminal for each of the switches turned on and to hold a result of the monitoring; and a control signal generation unit (13) configured to update, when the result of the monitoring for all the light-emitting units is held, a control signal (Ifb) used for feedback control on the power supply voltage in the power supply circuit (first configuration, FIG. 3).

In the configuration as described above, when the terminal voltages at the connection terminals are controlled, it is possible to suppress the occurrence of a ripple in the power supply voltage to stabilize the power supply voltage.

In the first configuration described above, the voltage monitoring unit (12) may include a minimum voltage determination unit (121) including: a first minimum voltage selection unit (121A) configured to select and output a minimum voltage among terminal voltages at the connection terminals in all the at least one channel; and a first comparator (121B) configured to compare an output of the first minimum voltage selection unit with a first reference voltage, and the result of the monitoring may be an output of the first comparator (second configuration, FIG. 3).

In the second configuration described above, the voltage monitoring unit may include a first latch block (122) configured to hold the result of the monitoring, the first latch block may include a plurality of first latch units (LT) that are provided to correspond to the plurality of groups and each of the plurality of first latch units may receive and hold the output of the first comparator based on a switch signal (SS) indicating the turning on and off of the switches and a current state signal (Spwm2) indicating turning on and off of the drive current (third configuration).

In the third configuration described above, the control signal generation unit (13) may include a logic circuit (131) configured to receive an output from each of the plurality of first latch units, and the control signal may be updated based on an output of the logic circuit (fourth configuration).

In the first configuration described above, the voltage monitoring unit (14) may include a first comparison block (141) including at least one second comparator (141 [i]) that is provided to correspond to the at least one channel, and is configured to compare a terminal voltage at the connection terminal in each of the at least one channel with a second reference voltage, and the result of the monitoring may be an output of the at least one second comparator (fifth configuration, FIG. 6).

In the fifth configuration described above, the voltage monitoring unit (14) may include a plurality of second latch blocks (142) that are provided to correspond to the plurality of groups, and are configured to hold the result of the monitoring, each of the plurality of second latch blocks may include at least one second latch unit (LT) that is provided to correspond to the at least one channel and each of the at least one second latch unit may receive and hold the output of the at least one second comparator based on a switch signal indicating the turning on and off of the switches and a current state signal indicating turning on and off of the drive current (sixth configuration, FIG. 6).

In the sixth configuration described above, the control signal generation unit (15) may include a logic circuit (151, 152) configured to receive an output from each of the at least one second latch unit, and the control signal may be updated based on an output of the logic circuit (seventh configuration, FIG. 6).

In the first configuration described above, the voltage monitoring unit (16) may include a plurality of sample-and-hold blocks (161) that are provided to correspond to the plurality of groups, each of the plurality of sample-and-hold blocks may include at least one sample-and-hold unit (SH) that is provided to correspond to the at least one channel and each of the at least one sample-and-hold unit may sample and hold a terminal voltage at the connection terminal in a corresponding one of the at least one channel based on a switch signal indicating the turning on and off of the switches and a current state signal indicating turning on and off of the drive current (eighth configuration, FIG. 7).

In the eighth configuration described above, the control signal generation unit (17) may include: a plurality of second minimum voltage selection units (171) that are provided to correspond to the plurality of groups; a plurality of third comparators (172) that are provided to correspond to the plurality of groups; and a logic circuit (173), each of the plurality of second minimum voltage selection units may select and output a minimum voltage among outputs from a corresponding one of the plurality of sample-and-hold blocks, each of the plurality of third comparators may compare an output of a corresponding one of the plurality of second minimum voltage selection units with a third reference voltage, the logic circuit may receive an output of each of the plurality of third comparators and the control signal may be updated based on an output of the logic circuit (ninth configuration, FIG. 7).

In the eighth configuration described above, the control signal generation unit (19) may include: a plurality of second comparison blocks (191) that are provided to correspond to the plurality of groups; and a logic circuit (192, 193), each of the plurality of second comparison blocks may include at least one fourth comparator (CMP) that is provided to correspond to the at least one channel, each of the at least one fourth comparator may compare an output from a corresponding one of the at least one sample-and-hold unit with a fourth reference voltage, the logic circuit may receive an output of each of the at least one fourth comparator and the control signal may be updated based on an output of the logic circuit (tenth configuration, FIG. 8).

In any one of the fourth, seventh, ninth and tenth configurations, the control signal generation unit (13) may include a DA converter (132) configured to update digital data based on the output of the logic circuit, the DA converter may update the digital data based on a synchronization signal (VSYNC) that specifies a start of a unit period during which the switches are sequentially turned on and the control signal may be updated based on an analog signal (VA) output from the DA converter (eleventh configuration, FIG. 3).

In the eleventh configuration, the power supply circuit (3) may include feedback resistors (R2, R3) connected between the application end of the power supply voltage and a ground end, and the control signal generation unit (13) may include a constant current circuit (133) configured to generate, as the control signal, based on the analog signal (VA), a current signal (Ifb) extracted from a node (N1) at which the feedback resistors are connected (twelfth configuration, FIG. 4).

A light-emitting system (SYS) according to an aspect of the present disclosure includes: the light-emitting element drive device (1) in any one of the first to twelfth configurations, the light-emitting units (LL) and the power supply circuit (3) (thirteenth configuration, FIG. 1).

A backlight (41) according to an aspect of the present disclosure includes: the light-emitting element drive device (1) in any one of the first to twelfth configurations; a light source unit (411) including the light-emitting units (LL) arranged in a matrix; and at least one optical member (412 to 414) to which light emitted from the light source unit is incident (fourteenth configuration, FIG. 9).

A display device (X) according to an aspect of the present disclosure includes: the backlight (41) in the fourteenth configuration; and a display panel (42) to which light emitted from the backlight is incident (fifteenth configuration).

### Industrial Applicability

The present disclosure can be utilized, for example, for an in-vehicle display and the like.

### DESCRIPTION OF REFERENCE NUMERALS

1 light-emitting element drive device
3 power supply circuit
3A DC/DC converter
8 wire
10 driver block
11 control block
12 voltage monitoring unit
13 FB control signal generation unit
14 voltage monitoring unit
15 FB control signal generation unit
16 voltage monitoring unit
17 FB control signal generation unit
19 FB control signal generation unit
20 control block
41 backlight
42 liquid crystal panel
101 light-emitting element drive device
102 light-emitting element drive device
102A FB control unit
102B FB current generation unit
121 minimum voltage determination unit
121A minimum voltage selection unit
121B comparator
122 latch block
123 AND circuit
131 OR circuit
132 DA converter
133 constant current circuit
133A error amplifier
133B output transistor
133C resistor
134 AND circuit
141 comparison block
142 latch block
151 OR circuit
152 OR circuit
153 DA converter
154 constant current circuit
161 sample-and-hold block
171 minimum voltage selection unit
172 comparator
173 OR circuit
174 DA converter
175 constant current circuit
191 comparison block
192 OR circuit
193 OR circuit
194 DA converter
195 constant current circuit
201 power supply circuit
201A DC/DC converter
411 light source unit
412 phosphor sheet
413 diffusion plate
414 optical sheets
DRV current driver
LL light-emitting unit
LT latch unit
R11, R12 feedback resistor
R1 to R3 feedback resistor
RISET current setting resistor
SH sample-and-hold unit
SW switch
SYS light-emitting system
SYS11 light-emitting system
SYS12 light-emitting system
X liquid crystal display device
Y in-vehicle display

1. A light-emitting element drive device used in a light-emitting system in which at least one channel of light-emitting units each including at least one light-emitting element are provided, and a plurality of groups including the at least one channel of light-emitting units are provided, the light-emitting element drive device comprising:
a connection terminal configured to be connectable to low potential ends of the at least one channel of light-emitting units;
a switch control unit configured to be capable of controlling turning on and off of a switch connected between high potential ends of the light-emitting units in each of the plurality of groups and an application end to which a power supply voltage output from a power supply circuit is applied;
a current driver configured to supply a drive current to the light-emitting unit via the connection terminal;
a voltage monitoring unit configured to monitor a voltage at a corresponding one of connection terminals each being the connection terminal for each of the switches turned on and to hold a result of the monitoring; and
a control signal generation unit configured to update, when the result of the monitoring for all the light-emitting units is held, a control signal used for feedback control on the power supply voltage in the power supply circuit.

2. The light-emitting element drive device according to claim 1,
wherein the voltage monitoring unit includes a minimum voltage determination unit including:
a first minimum voltage selection unit configured to select and output minimum voltage among terminal voltages at the connection terminals in all the at least one channel; and
a first comparator configured to compare an output of the first minimum voltage selection unit with a first reference voltage, and
the result of the monitoring is an output of the first comparator.

3. The light-emitting element drive device according to claim 2,
wherein the voltage monitoring unit includes a first latch block configured t hold the result of the monitoring,
the first latch block includes a plurality of first latch units that are provided correspond to the plurality of groups and
each of the plurality of first latch units receives and holds the output of the first comparator based on a switch signal indicating the turning on and off of the switches and a current state signal indicating turning on and off of the drive current.

4. The light-emitting element drive device according to claim 3,
wherein the control signal generation unit includes a logic circuit configured to receive an output from each of the plurality of first latch units, and
the control signal is updated based on an output of the logic circuit.

5. The light-emitting element drive device according to claim 1,
wherein the voltage monitoring unit includes a first comparison block including at least one second comparator that
is provided to correspond to the at least one channel, and
is configured to compare a terminal voltage at the connection terminal in each of the at least one channel with a second reference voltage, and
the result of the monitoring is an output of the at least one second comparator.

6. The light-emitting element drive device according to claim 5,
wherein the voltage monitoring unit includes a plurality of second latch blocks that
are provided to correspond to the plurality of groups, and
are configured to hold the result of the monitoring,
each of the plurality of second latch blocks includes at least one second latch unit that is provided to correspond to the at least one channel and
each of the at least one second latch unit receives and holds the output of the at least one second comparator based on a switch signal indicating the turning on and off of the switches and a current state signal indicating turning on and off of the drive current.

7. The light-emitting element drive device according to claim 6,
wherein the control signal generation unit includes a logic circuit configured to receive an output from each of the at least one second latch unit, and
the control signal is updated based on an output of the logic circuit.

8. The light-emitting element drive device according to claim 1,
wherein the voltage monitoring unit includes a plurality of sample-and-hold blocks that are provided to correspond to the plurality of groups,
each of the plurality of sample-and-hold blocks includes at least one sample-and-hold unit that is provided to correspond to the at least one channel and
each of the at least one sample-and-hold unit samples and holds a terminal voltage at the connection terminal in a corresponding one of the at least one channel based on a switch signal indicating the turning on and off of the switches and a current state signal indicating turning on and off of the drive current.

9. The light-emitting element drive device according to claim 8,
wherein the control signal generation unit includes:
a plurality of second minimum voltage selection units that are provided to correspond to the plurality of groups;
a plurality of third comparators that are provided to correspond to the plurality of groups; and
a logic circuit,
each of the plurality of second minimum voltage selection units selects and outputs a minimum voltage among outputs from a corresponding one of the plurality of sample-and-hold blocks,
each of the plurality of third comparators compares an output of a corresponding one of the plurality of second minimum voltage selection units with a third reference voltage,
the logic circuit receives an output of each of the plurality of third comparators and
the control signal is updated based on an output of the logic circuit.

10. The light-emitting element drive device according to claim 8,
wherein the control signal generation unit includes:
a plurality of second comparison blocks that are provided to correspond to the plurality of groups; and
a logic circuit,
each of the plurality of second comparison blocks includes at least one fourth comparator that is provided to correspond to the at least one channel,
each of the at least one fourth comparator compares an output from a corresponding one of the at least one sample-and-hold unit with a fourth reference voltage,
the logic circuit receives an output of each of the at least one fourth comparator and
the control signal is updated based on an output of the logic circuit.

11. The light-emitting element drive device according to claim 4,
wherein the control signal generation unit includes a DA converter configured update digital data based on the output of the logic circuit,
the DA converter updates the digital data based on a synchronization signal that specifies a start of a unit period during which the switches are sequentially turned on and
the control signal is updated based on an analog signal output from the DA converter.

12. The light-emitting element drive device according to claim 11,
wherein the power supply circuit includes feedback resistors connected between the application end of the power supply voltage and a ground end, and
the control signal generation unit includes a constant current circuit configured to generate, as the control signal, based on the analog signal, a current signal extracted from a node at which the feedback resistors are connected.

13. A light-emitting system comprising:
the light-emitting element drive device according to claim 1, the light-emitting units and the power supply circuit.

14. A backlight comprising:
the light-emitting element drive device according to claim 1;
a light source unit including the light-emitting units arranged in a matrix; and
at least one optical member to which light emitted from the light source unit is incident.

15. A display device comprising:
the backlight according to claim 14; and
a display panel to which light emitted from the backlight is incident.
